(19) United States
(12) Patent Application Publication
(10) Pub. No.: US 2012/0319375 A1
(43) Pub. Date: Dec. 20, 2012

(54) FRONT AXLE SYSTEM FOR A VEHICLE AND MOTOR VEHICLE

(75) Inventors: Lutz UHLENBRUCH, Herbstein (DE); Thomas DEGENSTEIN, Mainz (DE)

(73) Assignee: GM GLOBAL TECHNOLOGY OPERATIONS LLC, Detroit, MI (US)

(21) Appl. No.: 13/489,833

(22) Filed: Jun. 6, 2012

(30) Foreign Application Priority Data
Jun. 16, 2011 (DE) 10 2011 106 619.9

(51) Int. Cl. B62D 7/16

(52) U.S. Cl. 280/93.502

(57) ABSTRACT

A front axle system for a vehicle for receiving a total loading is provided. The front axle system includes a front axle frame element and a steering gear device connected to the front axle frame element. The front axle frame element is configured for receiving a first part of the total loading and the steering gear device is configured for receiving a second, remaining part of the total loading.

### CROSS-REFERENCE TO RELATED APPLICATION

This application claims priority to German Patent Application No. 10 2011 106 619.9, filed Jun. 16, 2011, which is incorporated herein by reference in its entirety.

### TECHNICAL FIELD

The technical field generally relates to a front axle system for a vehicle, in particular motor vehicle, for receiving a total loading. The technical field furthermore relates to a motor vehicle having such a front axle system.

### BACKGROUND

In motor vehicles, generally known auxiliary front axle frames, which are coupled to a steering gear, have to date been configured so that this auxiliary front axle frame can bear the total loading that is acting on the auxiliary front axle frame on its own. However, because of this, the auxiliary front axle frame has to be suitably dimensioned, as regards its size and stability. Additional installation space is required for this. In addition, the weight of the auxiliary front axle frame also increases because of this.

In DE 41 29 538 A1 a bogie for a motor vehicle is described. This bogie has two lateral parts running in a vehicle longitudinal direction, which are interconnected via cross members and comprise the mountings for links of wheel guiding members. This bogie unit consisting of lateral parts and cross members is connected to the vehicle chassis. The lateral parts are each formed from a torsionally stiff and rigid framework frame, which extends in a perpendicular longitudinal plane of the vehicle. Between the lateral parts, torsionally stiff cross members, each of which can be releasably screwed on, are held. With the lateral parts, these form a rigid assembly unit which comprises integrated mountings for links of wheel guiding members in the lateral parts.

It is at least one object herein to provide a front axle system for a vehicle that makes possible proofed distribution of the loading acting on the front axle system. In addition, other objects, desirable features and characteristics will become apparent from the subsequent summary and detailed description, and the appended claims, taken in conjunction with the accompanying drawings and this background.

### SUMMARY

In accordance with an exemplary embodiment, a front axle system for a vehicle, in particular motor vehicle, for receiving a total loading includes a front axle frame element and a steering gear device connected to the front axle frame element. The front axle frame element is configured for receiving a first part of the total loading, and the steering gear device is configured for receiving a second, residual part of the total loading.

In another embodiment, a motor vehicle having such a front axle system is provided.

The total loading is divided and is absorbed by a front axle system, having a front axle frame element and a steering gear device, over the elements of the front axle system, i.e. over the steering gear device and the front axle frame element. The steering gear device to this end is integrated in the front axle frame element and the front axle frame element is embodied or dimensioned so that it can absorb a first part of the total loading. Furthermore, the steering gear device is embodied or dimensioned in such a manner that it can absorb a second and in particular the remaining part of the total loading.

In this regard, the total loading, which is to be absorbed by the front axle system, is now better divided and is thus also better distributed. The front axle frame element can thus be dimensioned smaller, less solid and additionally lighter, since it only needs to absorb a part of the total loading, while the steering gear device, for example, absorbs the remaining part of the total loading. Because of this, the weight and the volume of front axle frame element and steering gear device as a whole can be reduced and the installation space that has become additionally vacant in the front axle region of a motor vehicle can be utilized otherwise.

In an embodiment, the steering gear device comprises a steering gear housing, which is fastened to the front axle frame element as a cross member. In particular, the steering gear housing is rigidly fastened to the front axle frame element. The steering gear housing can, for example, absorb such transverse forces that act on the front axle frame element.

In another embodiment, the steering gear housing is releasably fastened to the front axle frame element by a fastening means. As fastening means, for example, a screw or a bolt can be provided. Through the releasable fastening, different steering gear housings, depending on function and purpose, can be combined with the front axle frame element.

In a further embodiment, the steering gear housing comprises a connection section at an end or a middle section for fastening to the front axle frame element.

In another embodiment, the connection section is unitarily formed with the steering gear housing. Here, the connection section can form, for example, a unitary casting with the steering gear housing. This is simple and cost-effective in terms of production. In addition, no additional fastening means for connecting the connection section to the steering gear housing are necessary.

According to a further embodiment, the front axle frame element and the steering gear housing are interconnected through a positive and/or frictional connection. Here, the front axle frame element can, for example, comprise a positive connection element, e.g. a dowel sleeve or another suitable positive connection element. The steering gear housing then comprises, for example, a section corresponding to the positive connection element for positive connection receiving in the positive connection element. With this positive connection between the positive connection element and the section, no additional fastening means for connecting steering gear housing and front axle frame element are necessary.

In another embodiment, an installation space that is sufficient for receiving a further component is provided between the front axle frame element and the steering gear housing, for example, a section of an exhaust device. This is made possible in that the front axle frame element because of its dimensioning only has to absorb a part of a total loading.

In one embodiment, a cross brace is provided on the front axle frame element.

The front axle frame element can form a mold division plane with the connection section of the steering gear housing.

In another embodiment, the front axle frame element is configured for fastening to a front frame of a vehicle as an auxiliary front axle frame. The auxiliary front axle frame has two lateral sections in vehicle longitudinal direction, which are interconnected via a connecting section.

In a further embodiment, the motor vehicle comprises an exhaust device, which is arranged at least partially in an installation space between the front axle frame element and the steering gear device. The exhaust or the exhaust device however need not be necessarily arranged there, but can, for example, also be located above the steering gear.

If practical, the above configurations and further developments can be combined as required. Further possible configurations, further developments, and further implementations also comprise combinations of features previously described before or in the following with respect to exemplary embodiments not mentioned explicitly. In particular, the person skilled in the art will also add individual aspects as improvements or additions to the respective basic form of the various embodiments.

### BRIEF DESCRIPTION OF THE DRAWINGS

The various embodiments will hereinafter be described in conjunction with the following drawing figures, wherein like numerals denote like elements, and wherein:

FIG. 1 is a perspective view of an embodiment of a system of a front axle frame element of a vehicle that is connected to a steering gear housing;

FIG. 2 is a further perspective view of the front axle frame element and the steering gear housing according to FIG. 1 connected with it;

FIG. 3 is a front view of the front axle frame element and the steering gear housing according to FIG. 1 connected with it; and

FIG. 4 is a top view of the front axle frame element and the steering gear housing according to FIG. 1 connected with it.

### DETAILED DESCRIPTION

The following detailed description is merely exemplary in nature and is not intended to limit the various embodiments or the application and uses thereof. Furthermore, there is no intention to be bound by any theory presented in the preceding background and summary or the following detailed description.

FIG. 1 shows a perspective view of an embodiment of a front axle system consisting of a front axle frame element 1 and a steering gear housing 2 of a steering gear device 3 connected with it.

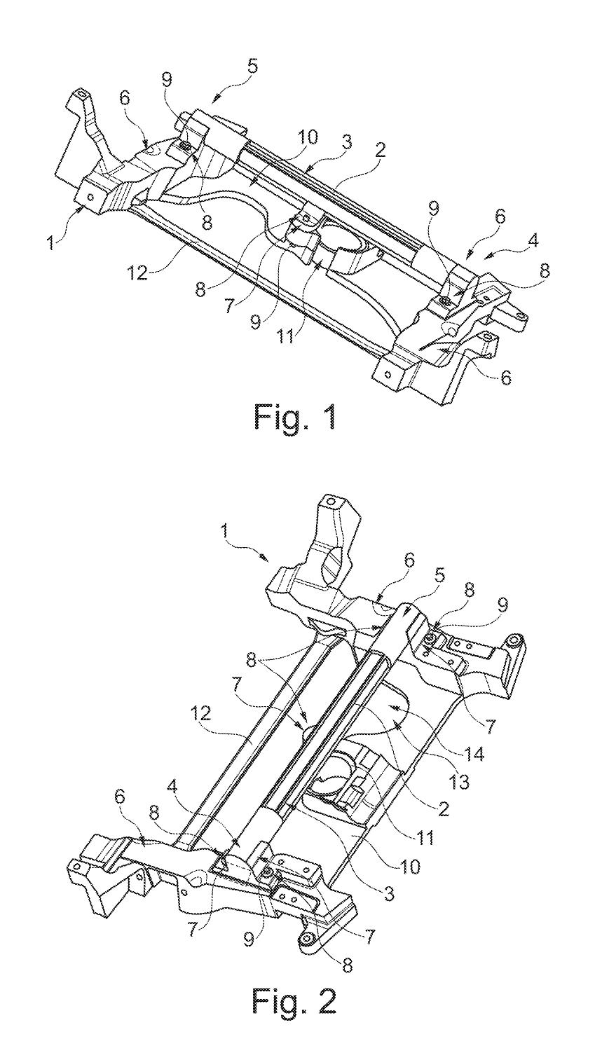

The front axle frame element 1 shown in the exemplary embodiment in FIG. 1 and the following FIGS. 2 to 4 in this case is for example an auxiliary front axle frame, which can be connected to the remaining vehicle body and in particular to a front frame of the vehicle, in particular motor vehicle.

Up to now, the auxiliary front axle frame and the steering gear device, and in particular, its steering gear housing are designed independently of each other. This means that the auxiliary front axle frame is designed and dimensioned in such a manner that it fully absorbs the total forces or the total loading acting on it. The steering gear housing is designed so that it hardly absorbs any forces that are introduced, for example, by way of the lower cross member or can additionally absorb a part of the total forces or the total loading. The auxiliary front axle frame and steering gear housing are developed separately, which results in that, rigidly screwed together, they can be able to absorb more forces or loads than are actually required. As a consequence, the auxiliary front axle frame and the steering gear housing as a whole are designed in an over-dimensioned manner and because of this have additional weight and need additional space.

The various embodiments herein integrate a steering gear device 3 in an auxiliary front axle frame-body structure. According to an embodiment, the steering gear device 3 is integrated in the auxiliary front axle frame 1. The front axle system is configured for being able to absorb a predetermined or predefined total loading. According to an embodiment, the auxiliary front axle frame 1 is configured so that it can absorb a part of the total loading, e.g., ⅔ or ¾ of the total loading. The steering gear device 3 is configured in such a manner that it can absorb the remaining part of the total loading, e.g. ⅓ or ¼, respectively, of the total loading.

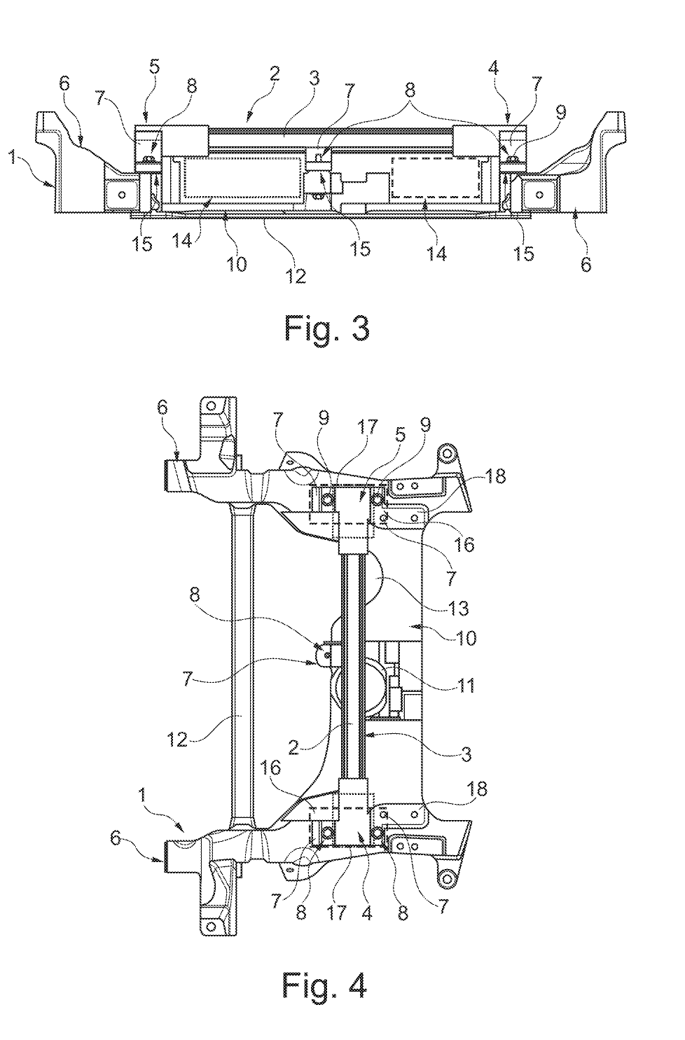

Through the optimization of the topology of the auxiliary front axle frame 1 and the steering gear device 3 and its steering gear housing 2, these parts can be dimensioned smaller and, because of this, made significantly lighter. In addition, additional installation space can be created for arranging, for example, an exhaust device or another component between the auxiliary front axle frame 1 and the steering gear device 3, as is indicated in the following FIG. 3 by a dotted line.

In the exemplary embodiment in FIG. 1, the steering gear housing 2 of the steering gear device 3 is fastened, preferentially releasably fastened, for example, at its both ends 4, 5 to two lateral sections 6 of the auxiliary front axle frame 1. The steering gear housing 2 serves as a cross member. Through this configuration, the steering gear housing 2 of the steering gear device 3 can be utilized in particular in order to absorb transverse forces or a transverse loading. As is shown in the exemplary embodiment in FIG. 1, the steering gear housing 2 can also be embodied with one or a plurality of connecting sections 7, by means of which the steering gear housing 2 is fastened to the auxiliary front axle frame 1, preferentially releasably fastened. As fastening means 8 for fastening the steering gear housing 2 with its restrictive connecting section 7 to the auxiliary front axle frame 1, screws 9, pins, threaded bolts, etc., can be provided, for example. At least one connecting section 7 can be unitarily formed with the steering gear housing 2, e.g., as a casting.

Optionally, an additional fastening, preferentially a releasable fastening, of the steering gear housing 2 to a connecting section 10 of the auxiliary front axle frame 1 can be provided, which interconnects the two lateral sections 6 in a vehicle transverse direction. Here, the steering gear housing 2 can, for example, be fastened to the connecting section 10 of the auxiliary front axle frame 1 in or near the middle or in the region of the cylinder 11 for the engine mounting, as shown in the exemplary embodiment in FIG. 1. To this end, the steering gear housing 2 can be provided with a connecting section 7 on one or both sides, which, for example, is provided unitarily or as a separate part on the steering gear housing 2.

The steering gear housing 2 in the exemplary embodiment in FIG. 1 is fastened or rigidly fastened to the auxiliary front axle frame 1 by means of screws 9 as fastening means 8. In addition to screws 9 as fastening means 8, pins, threaded bolts or any other fastening means, which are suitable for connecting the steering gear housing 2 to the auxiliary front axle frame 1, in particular releasably connecting, can be provided.

Likewise, the steering gear housing 2 can also be welded and/or soldered to the auxiliary front axle frame 1 for fastening.

In addition or alternatively to the fastening by means of fastening means 8 such as for example screws 9, pins etc., a positive connection and/or frictional connection can also be provided, for connecting the steering gear housing 2 to the auxiliary front axle frame 1, as is explained in more detail in the following FIG. 4. To this end, the auxiliary front axle frame 1, for example, can comprise a positive connection element such as, for example, a receptacle or a dowel sleeve, etc., for the positive connection receiving of a corresponding section or fitted section of the steering gear housing 2. The positive connection element, such as the receptacle or dowel sleeve, can be provided on at least one of the lateral sections 6 and/or on the connecting section 10 of the auxiliary front axle frame 1. Alternatively or additionally, the steering gear housing 2 can also be provided with a positive connection element such as, for example, a receptacle or dowel sleeve, for the positive connection receiving of a corresponding section of the auxiliary front axle frame 1. In the exemplary embodiment shown in FIG. 1, an additional cross brace 12 or cross member can be optionally provided on the auxiliary front axle frame 1, for the additional stiffening or reinforcement of the auxiliary front axle frame 1. The cross brace 12 or the cross member can, for example, be an extruded profile that additionally supports the structure. In addition, the cross brace 12 or the cross member can be provided on the front, the back, above and/or below the auxiliary front axle frame 1, in order to additionally reinforce the structure.

FIG. 2 shows a further perspective view of the auxiliary front axle frame 1 and the steering gear housing 2 according to FIG. 1 connected with it.

The steering gear housing 2 comprises the respective connecting section 7, for example, at one or both ends 4, 5, e.g., on at least one side or both sides of each end 4, 5, as is shown in the exemplary embodiments in FIG. 2, for fastening the steering gear housing 2 to the auxiliary front axle frame 1 by fastening means 8, such as, for example, screws 9, pins etc. Likewise, a connecting section 7 can also be provided additionally or alternatively in transverse direction of the steering gear housing 2 on at least one end 4, as is indicated by a dash-dotted line in the exemplary embodiment in FIG. 2.

In addition or alternatively, as described above, the connecting section 7 can be provided on one or both sides of the steering gear housing 2, for fastening the steering gear housing 2 to the connecting section 10 of the auxiliary front axle frame element 1.

The auxiliary front axle frame 1 can be embodied with a recess 13, in which, for example, a part of an exhaust device (not shown) can be arranged. By integrating the steering gear device 3 and its steering gear housing 2 in the auxiliary front axle frame 1 and optimizing the topology of these parts, such a recess 13 can be provided on the auxiliary front axle frame 1. In addition, adequate additional space can be provided between the auxiliary front axle frame 1 and the steering gear housing 2 for arranging, for example, a part of the exhaust device. The reasons for this is that the auxiliary front axle frame 1 can be configured less solid because it does not need to absorb the total forces or the total loading alone, as has been the case up to now.

Because of a releasable connection of the steering gear housing 2 to the auxiliary front axle frame 1, different steering gear devices 3 and their steering gear housings 2 can be additionally combined with the auxiliary front axle frame 1, for example, hydraulics, electric, and/or mechanical steering gear devices 3. Because of this, a modular concept can be provided, wherein the steering gear device 3 and its steering gear housing 2 form a structural component of the auxiliary front axle frame 1 and can be exchanged on the auxiliary front axle frame 1 dependent on function and purpose.

FIG. 3 shows a front view of the auxiliary front axle frame 1 and the steering gear housing 2 according to FIG. 1 connected to it. Here, the steering gear housing 2 is screwed to the auxiliary front axle frame 1, for example, by means of screws 9 as fastening means 8 via its connecting section 7 and forms a cross member for receiving in particular transverse forces, as described before.

In that the auxiliary front axle frame 1 has to be configured less solid and the steering gear housing 2 can be merely configured slightly stiffer and is additionally rigidly fastened to the auxiliary front axle frame 1, an additional installation space 14 can be provided between the auxiliary front axle frame 1 and the cross member or the steering gear device 3, as is indicated by a dotted line and an interrupted line in FIG. 3.

A part, for example, of an exhaust device can hereby be provided for example in the installation space 14 between the auxiliary front axle frame 1 and the steering gear housing 2, which is indicated by the dotted line in the exemplary embodiment in FIG. 3.

FIG. 4 additionally shows a top view of the auxiliary front axle frame 1 and the steering gear housing 2 according to FIG. 1 connected with it. The auxiliary front axle frame element 1 has the two elongated lateral sections 6, which are interconnected via the connecting section 10 running transversely thereto. The auxiliary front axle frame 1 with its two lateral sections 6 and the connecting section 10 is preferentially embodied unitarily and can be optionally reinforced additionally via at least one cross brace 12 or a cross member.

The two lateral sections 6 of the auxiliary front axle frame 1 can for example form a lower shearing surface or mold division plane 15 (see also FIG. 3) with the connecting sections 7 of the steering gear housing 2. The steering gear housing 2 and its connecting sections 7 preferentially have a geometry that allows a fixed connection of the steering gear device 3 to the lateral sections 6 of the auxiliary front axle frame 1. As described before, the connecting section 7 can be provided on at least one side of an end 4, 5 of the steering gear housing 2 and for example be unitarily formed with the latter.

In addition, as is previously shown by a dash-dotted line in the exemplary embodiment in FIG. 2, a connecting section 7 can be configured elongated in a transverse direction of the auxiliary front axle frame 1. The number and arrangement of the fastening means 8, in this case for example screws 9, can be varied as required depending on function and purpose.

Additionally or alternatively to the fastening by fastening means 8, such as for example screws 9, pins etc., a positive connection and/or a frictional connection can also be provided as described before, for connecting the steering gear housing 2 to the auxiliary front axle frame 1. As is indicated in the exemplary embodiment in FIG. 4, the auxiliary front axle frame element 1 can comprise a positive connection element each on one or both ends 4, 5, such as, for example, a dowel sleeve 16 (interrupted line), in which a corresponding section or fitted section 17 (dotted line) of the steering gear housing 2 can be inserted and absorbed and positively connected to the latter.

The embodiment of an auxiliary front axle frame element 1 previously described with reference to FIGS. 1 to 4 with a steering gear device 3 integrated in the auxiliary front axle frame 1 better utilizes the installation space in the vehicle, in particular in a motor vehicle. Furthermore, the weight can be reduced since the combination of the auxiliary front axle frame and the steering gear housing is configured in such a manner that they together absorb the entire transverse loading to be absorbed.

In addition, the operating efficiency can be ensured because of the fixed connection between the steering gear housing and the auxiliary front axle frame. By integrating the steering gear device with its steering gear housing in the auxiliary front axle frame, the stiffness of the latter can be increased and the operating efficiency ensured at the same time.

While at least one exemplary embodiment has been presented in the foregoing detailed description, it should be appreciated that a vast number of variations exist. In particular, the front axle system contemplated herein is not restricted to the shown exemplary embodiments of connecting sections of the steering gear device and the mentioned fastening means as well as the exemplary embodiment for a positive connection. Any other form of fastening can be provided which allows a rigid and preferentially releasable fastening of the steering gear housing to the auxiliary front axle frame. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A front axle system for a vehicle for receiving a total loading, the front axle system comprising:
a front axle frame element;
a steering gear device connected to the front axle frame element,
wherein the front axle frame element is configured for receiving a first part of the total loading, and wherein the steering gear device is configured for receiving a second, remaining part of the total loading.

2. The front axle system according to claim 1 wherein the vehicle is a motor vehicle.

3. The front axle system according to claim 1, wherein the steering gear device comprises a steering gear housing that is fastened to the front axle frame element as a cross member.

4. The front axle system according to claim 3, wherein the steering gear housing is releasably fastened to the front axle frame element by a fastening means.

5. The front axle system according to claim 4, wherein the steering gear housing comprises a connecting section on an end or a middle section for fastening to the front axle frame element.

6. The front axle system according to claim 5, wherein the connecting section is configured unitarily with the steering gear housing and forms a unitary casting with the steering gear housing.

7. The front axle system according to claim 5, wherein the front axle frame element forms a mold division plane with the connecting section of the steering gear housing.

8. The front axle system according to claim 3, wherein the front axle frame element and the steering gear housing are interconnected through a positive and/or frictional connection, wherein the front axle frame element comprises a positive connection element and wherein the steering gear housing comprises a fitted section that is received by the positive connection element.

9. The front axle system according to claim 3, wherein between the front axle frame element and the steering gear housing an installation space for receiving a further component of the vehicle is formed.

10. The front axle system according to claim 9, wherein the further component is a section of an exhaust device.

11. The front axle system according to claim 1, wherein a cross brace is provided on the front axle frame element.

12. The front axle system according to claim 1, wherein the front axle frame element is configured as an auxiliary front axle frame for fastening to a front frame of the vehicle and comprises two lateral sections in a vehicle longitudinal direction, wherein the two lateral sections are interconnected via a connecting section.

13. A motor vehicle having a front axle system for receiving a total loading, the front axle system comprising:
a front axle frame element;
a steering gear device connected to the front axle frame element,
wherein the front axle frame element is configured for receiving a first part of the total loading, and wherein the steering gear device is configured for receiving a second, remaining part of the total loading.

14. The motor vehicle according to claim 13, wherein the steering gear device comprises a steering gear housing that is fastened to the front axle frame element as a cross member.

15. The motor vehicle according to claim 14, wherein the steering gear housing is releasably fastened to the front axle frame element by a fastening means.

16. The motor vehicle according to claim 14, wherein the steering gear housing comprises a connecting section on an end or a middle section for fastening to the front axle frame element.

17. The motor vehicle according to claim 16, wherein the connecting section is configured unitarily with the steering gear housing and forms a unitary casting with the steering gear housing.

18. The motor vehicle according to claim 16, wherein the front axle frame element forms a mold division plane with the connecting section of the steering gear housing.

19. The motor vehicle according to claim 14, wherein the front axle frame element and the steering gear housing are interconnected through a positive and/or frictional connection, wherein the front axle frame element comprises a positive connection element and wherein the steering gear housing comprises a fitted section that is received by the positive connection element.

20. The motor vehicle according to claim 13, wherein the motor vehicle comprises an exhaust device that at least partially arranged in an installation space between the front axle frame element and the steering gear device.
